(19) United States
(12) Patent Application Publication
(10) Pub. No.: US 2024/0343265 A1
(43) Pub. Date: Oct. 17, 2024

(54) AUTONOMOUS DRIVING SYSTEM AND CONTROL METHOD FOR VEHICLE

(71) Applicant: TOYOTA JIDOSHA KABUSHIKI KAISHA, Toyota-shi (JP)

(72) Inventor: Hironori ITO, Tokyo-to (JP)

(21) Appl. No.: 18/749,703

(22) Filed: Jun. 21, 2024

Related U.S. Application Data
(63) Continuation of application No. 17/498,845, filed on Oct. 12, 2021.

(30) Foreign Application Priority Data
Oct. 15, 2020 (JP) 2020-173988

(51) Int. Cl. B60W 50/14; B60W 60/00; G06F 3/14; G06V 20/58

(52) U.S. Cl. CPC B60W 50/14; B60W 60/001; G06F 3/14; B60W 2050/146; B60W 2552/10; B60W 2554/4041; B60W 2554/4045; B60W 2554/802; B60W 2720/106; G06V 20/584

(57) ABSTRACT

An autonomous driving system includes a vehicle detection device for detecting surrounding vehicles present in surroundings of a host vehicle, a display device for displaying the surrounding vehicles detected by the vehicle detection device as vehicle icons, and a processor configured to control display content of the display device, control autonomous driving of the host vehicle, and set a vehicle necessitating deceleration from among the surrounding vehicles detected by the vehicle detection device. The processor is configured to control acceleration and deceleration of the host vehicle so that the host vehicle does not approach the vehicle necessitating deceleration, and when a plurality of surrounding vehicles detected by the vehicle detection device are displayed on the display device, the processor is configured to display a vehicle icon of the vehicle necessitating deceleration in a display mode different from vehicle icons of remaining surrounding vehicles.

### RELATED APPLICATIONS

This application is a continuation of U.S. patent application Ser. No. 17/498,845, filed Oct. 12, 2021, which claims priority to JP Patent Application No. 2020-173988, filed Oct. 15, 2020, the disclosures of which are incorporated herein in their entireties.

### FIELD

The present disclosure relates to an autonomous driving system and a control method for a vehicle.

### BACKGROUND

It has been known in the past to provide information on the surroundings to a driver of an autonomous driving-capable vehicle by displaying surrounding vehicles that are detected by a vehicle detection device mounted in the vehicle on a display device inside the vehicle. In the driving control device described in PTL 1, if a plurality of surrounding vehicles present in the surroundings of a host vehicle are detected, these plurality of surrounding vehicles are displayed on a display device.

### CITATIONS LIST

### Patent Literature

[PTL 1] Japanese Unexamined Patent Publication No. 2017-187982

### SUMMARY

### Technical Problem

In this regard, when autonomous driving of the vehicle is performed, the autonomous driving of the vehicle is controlled so that collisions with detected surrounding vehicles are avoided. In particular, a surrounding vehicle that would interfere with smooth driving by the vehicle is set as a vehicle necessitating deceleration, and acceleration and deceleration of the vehicle are controlled such that the vehicle does not approach the vehicle necessitating deceleration.

Accordingly, the control of the vehicle changes depending on the presence of any vehicle necessitating deceleration. Therefore, it is desirable that a person monitoring autonomous driving such as the driver of the vehicle be able to quickly grasp the set state of a vehicle necessitating deceleration. However, when a plurality of surrounding vehicles are displayed on a display device, it is difficult to differentiate a vehicle necessitating deceleration among the plurality of surrounding vehicles.

In consideration of the above problem, an object of the present disclosure is to facilitate differentiation of a vehicle necessitating deceleration on a display device if a plurality of surrounding vehicles present in the surroundings of a host vehicle are displayed on a display device.

### Solution to Problem

The summary of the present disclosure is as follows.

(1) An autonomous driving system comprising: a vehicle detection device for detecting surrounding vehicles present in surroundings of a host vehicle; a display device for displaying the surrounding vehicles detected by the vehicle detection device as vehicle icons; and a processor configured to control display content of the display device, control autonomous driving of the host vehicle, and set a vehicle necessitating deceleration from among the surrounding vehicles detected by the vehicle detection device, wherein the processor is configured to control acceleration and deceleration of the host vehicle so that the host vehicle does not approach the vehicle necessitating deceleration, and when a plurality of surrounding vehicles detected by the vehicle detection device are displayed on the display device, the processor is configured to display a vehicle icon of the vehicle necessitating deceleration in a display mode different from vehicle icons of remaining surrounding vehicles.

(2) The autonomous driving system described in above (1), wherein when the vehicle necessitating deceleration is positioned in an adjacent lane of the host vehicle and a preceding vehicle is detected in a driving lane of the host vehicle, if a distance between the host vehicle and the vehicle necessitating deceleration is shorter than a distance between the host vehicle and the preceding vehicle, the processor is configured to display the vehicle icon of the vehicle necessitating deceleration in a display mode different from the vehicle icons of the remaining surrounding vehicles.

(3) The autonomous driving system described in above (1) or (2), wherein when the vehicle necessitating deceleration is positioned in an adjacent lane of the host vehicle and a preceding vehicle is not detected in a driving lane of the host vehicle, if a distance between the host vehicle and the vehicle necessitating deceleration is shorter than a predetermined distance, the processor is configured to display the vehicle icon of the vehicle necessitating deceleration in a display mode different from the vehicle icons of the remaining surrounding vehicles.

(4) The autonomous driving system described in any one of above (1) to (3), wherein the processor is configured to display the vehicle icon of the vehicle necessitating deceleration so that the vehicle necessitating deceleration is the most emphasized among the plurality of surrounding vehicles displayed on the display device.

(5) The autonomous driving system described in any one of above (1) to (4), wherein when the vehicle necessitating deceleration is present in an adjacent lane of the host vehicle, the processor is configured to display the vehicle icon of the vehicle necessitating deceleration so that the vehicle necessitating deceleration is emphasized more compared to when the vehicle necessitating deceleration is present in a driving lane of the host vehicle.

(6) The autonomous driving system described in any one of above (1) to (5), wherein the processor is configured to display a vehicle icon of a first preceding vehicle positioned in front of the host vehicle in a driving lane of the host vehicle and closest to the host vehicle in a display mode different from the vehicle icons of the remaining surrounding vehicles.

(7) The autonomous driving system described in above (6), wherein if a distance between the first preceding vehicle and the host vehicle is shorter than a predetermined distance, the processor is configured to display the vehicle icon of the first preceding vehicle in a display mode different from the vehicle icons of the remaining surrounding vehicles.

(8) The autonomous driving system described in above (6) or (7), wherein the processor is configured to display the vehicle icon of the first preceding vehicle so that the first preceding vehicle is emphasized more than surrounding vehicles besides the vehicle necessitating deceleration.

(9) The autonomous driving system described in any one of above (6) to (8), wherein when a lane change of the host vehicle is being executed by the vehicle control part, the processor is configured to display a vehicle icon of a surrounding vehicle positioned in front of the host vehicle in a lane after the lane change and closest to the host vehicle, in place of the first preceding vehicle, in a display mode different than the vehicle icons of the remaining surrounding vehicles.

(10) The autonomous driving system described in any one of above (1) to (5), wherein when a surrounding vehicle displayed on the display device is set as the vehicle necessitating deceleration, the processor is configured to change a display mode of a vehicle icon of the surrounding vehicle.

(11) The autonomous driving system described in any one of above (1) to (9), wherein when a surrounding vehicle present in the adjacent lane of the host vehicle and displayed on the display device is set as the vehicle necessitating deceleration, the processor is configured to change the display mode of a vehicle icon of the surrounding vehicle.

(12) A control method for a vehicle comprising a vehicle detection device for detecting surrounding vehicles and a display device for displaying the surrounding vehicles detected by the vehicle detection device as vehicle icons, including: setting a vehicle necessitating deceleration from among the surrounding vehicles detected by the vehicle detection device; controlling acceleration and deceleration of the vehicle so that the vehicle does not approach the vehicle necessitating deceleration; and when a plurality of surrounding vehicles detected by the vehicle detection device are displayed on the display device, displaying a vehicle icon of the vehicle necessitating deceleration in a display mode different from vehicle icons of remaining surrounding vehicles.

According to the present disclosure, it is possible to facilitate differentiation of a vehicle necessitating deceleration on a display device if a plurality of surrounding vehicles present in the surroundings of a host vehicle are displayed on a display device.

### BRIEF DESCRIPTION OF DRAWINGS

FIG. 1 is a view schematically showing the configuration of an autonomous driving system according to a first embodiment of the present disclosure.

FIG. 2 is a view schematically showing a part of the configuration of a vehicle in which the autonomous driving system according to the first embodiment of the present disclosure is mounted.

FIG. 3 is a functional block diagram of the ECU of FIG. 1.

FIG. 4 is a view showing one example of an image displayed on a display device.

FIG. 5 is a flow chart showing a control routine for surrounding vehicle display processing in the first embodiment.

FIG. 6 is a flow chart showing a control routine for surrounding vehicle display processing in a second embodiment.

FIG. 7A is a flow chart showing a control routine for surrounding vehicle display processing in a third embodiment.

FIG. 7B is a flow chart showing a control routine for surrounding vehicle display processing in the third embodiment.

FIG. 8 is a flow chart showing a control routine for surrounding vehicle display processing in a fourth embodiment.

FIG. 9 is a flow chart showing a control routine for surrounding vehicle display processing in a fifth embodiment.

FIG. 10 is a flow chart showing a control routine for surrounding vehicle display processing in a sixth embodiment.

### DESCRIPTION OF EMBODIMENTS

Below, referring to the drawings, embodiments of the present disclosure will be explained in detail. Note that, in the following explanation, similar component elements will be assigned the same reference notations.

### First Embodiment

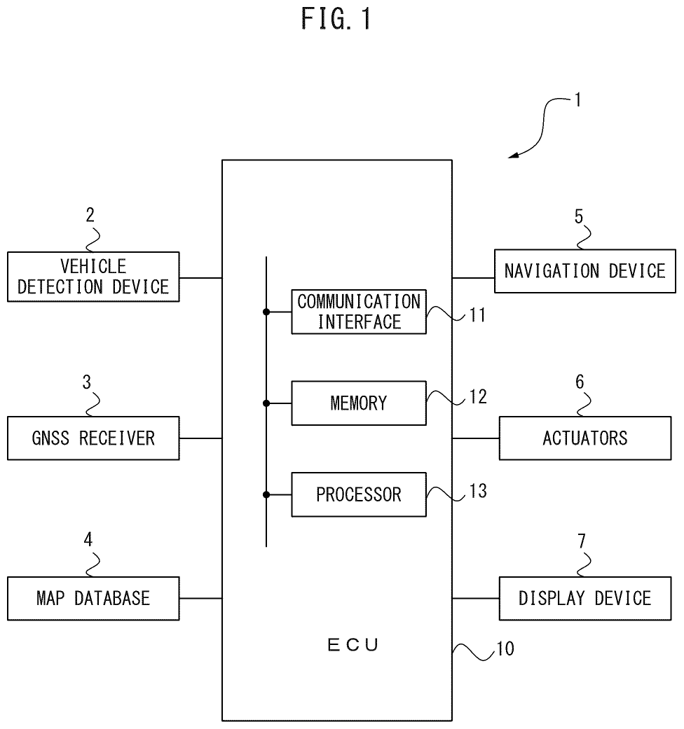

First, referring to FIG. 1 to FIG. 5, a first embodiment of the present disclosure will be explained.

### <Configuration of Autonomous Driving System>

FIG. 1 is a view schematically showing the configuration of an autonomous driving system 1 according to the first embodiment of the present disclosure. The autonomous driving system 1 is mounted in a vehicle and performs autonomous driving of the vehicle. In autonomous driving of a vehicle, a part or all of acceleration, steering, and braking of the vehicle are performed automatically. That is, a vehicle in which the autonomous driving system 1 is mounted is a so-called “autonomous driving vehicle”.

As shown in FIG. 1, the autonomous driving system 1 is provided with a vehicle detection device 2, a GNSS receiver 3, a map database 4, a navigation device 5, actuators 6, a display device 7, and an electronic control unit (ECU) 10. The vehicle detection device 2, the GNSS receiver 3, the map database 4, the navigation device 5, the actuators 6, and the display device 7 are provided in the vehicle and are connected through an internal vehicle network based on the CAN (Controller Area Network) or other standards to be able to communicate with the ECU 10.

The vehicle detection device 2 detects surrounding vehicles present in the surroundings of the vehicle (host vehicle). Specifically, the vehicle detection device 2 detects presence or absence of a surrounding vehicle around the vehicle, the distance of the surrounding vehicle to the vehicle, and the relative speed between the vehicle and the surrounding vehicle. The output of the vehicle detection device 2 is transmitted to the ECU 10. In the present embodiment, the vehicle detection device 2 is constituted by an external camera, a LIDAR (laser imaging detection and ranging device), a milliwave radar, an ultrasonic sensor (sonar), or any combination of the same.

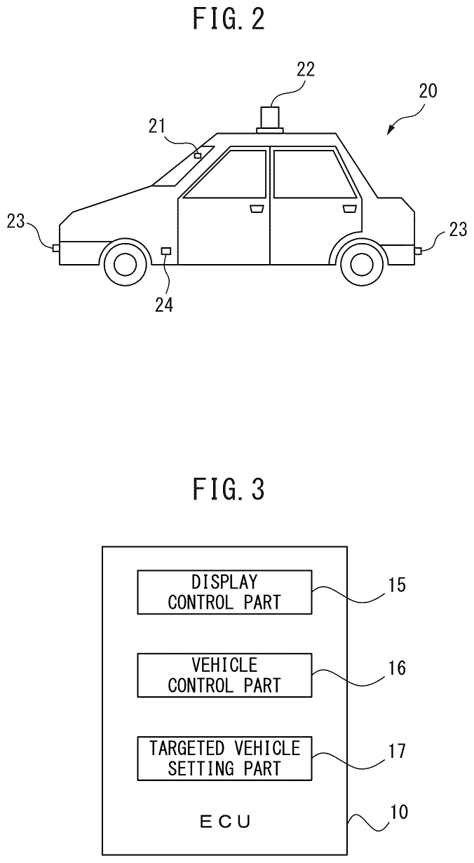

FIG. 2 is a view schematically showing a part of the configuration of a vehicle 20 in which an autonomous driving system 1 according to the first embodiment of the present disclosure is mounted. As shown in FIG. 2, the vehicle 20 is provided with a vehicle-mounted camera 21, a LIDAR 22, a milliwave radar 23 and an ultrasonic sensor (sonar) 24.

The vehicle-mounted camera 21 captures the surroundings of the vehicle 20 and generates images of the surroundings of the vehicle 20. In the present embodiment, the vehicle-mounted camera 21 is arranged at the front of the vehicle 20 (for example, the back surface of the room mirror inside the vehicle, the front bumper, etc.) so as to capture the front region of the vehicle 20. Note that the vehicle-mounted camera 21 may be a stereo camera able to measure distance.

The LIDAR 22 emits laser beams to the surroundings of the vehicle 20 and receives reflections of the laser beams. Due to this, the LIDAR 22 can detect the presence of any object in the surroundings of the vehicle 20, the distance from the vehicle 20 to the object, and the relative speed of the vehicle 20 and the object. In the present embodiment, the LIDAR 22 is provided at the top part of the vehicle 20, specifically on the roof of the vehicle 20.

The milliwave radar 23 emits milliwaves to the surroundings of the vehicle 20 and receives reflections of the milliwaves. Due to this, the milliwave radar 23 can detect the presence of any object in the surroundings of the vehicle 20, the distance from the vehicle 20 to the object, and the relative speed of the vehicle 20 and the object. In the present embodiment, milliwave devices 23 are provided at the front part and the rear part of the vehicle 20 (for example, the front bumper and the rear bumper of the vehicle 20).

The ultrasonic sensor 24 emits ultrasonic waves to the surroundings of the vehicle 20 and receives reflections of the ultrasonic waves. Due to this, the ultrasonic sensor 24 can detect the presence of any object in the surroundings of the vehicle 20, the distance from the vehicle 20 to the object, and the relative speed of the vehicle 20 and the object. In the present embodiment, ultrasonic sensors 24 are provided at the both side parts of the vehicle (for example, the left and right front bumpers of the vehicle 20).

Note that the positions and numbers of the vehicle-mounted camera 21, the LIDAR 22, the milliwave radar 23, and the ultrasonic sensor 24 are not limited to the above. Further, some of these may be omitted.

The GNSS receiver 3 captures a plurality of positioning satellites and receives radio waves transmitted from the positioning satellites. The GNSS receiver 3 calculates the distances to the positioning satellites based on the difference between the time of transmission and time of reception of the radio waves and detects the current position of the vehicle 20 (for example, the longitude and latitude of the vehicle 20) based on the distances to the positioning satellites and the positions of the positioning satellites (orbit information). The output of the GNSS receiver 3 is transmitted to the ECU 10. Note that “GNSS (global navigation satellite system)” is a general term for the United States' GPS, Russia's GLONASS, Europe's Galileo, Japan's QZSS, China's BeiDou, and India's IRNSS, and other satellite positioning systems. Therefore, the GNSS receiver 3 includes a GPS receiver.

The map database 4 stores map information. The map information stored in the map database 4 is updated using communication with the outside of the vehicle 20, SLAM (simultaneous localization and mapping), etc. The ECU10 acquires map information from the map database 4.

The navigation device 5 sets a driving route of the vehicle 20 to a destination based on the current position of the vehicle 20 detected by the GNSS receiver 3, the map information of the map database 4, inputs by the driver, etc. The driving route set by the navigation device 5 is transmitted to the ECU 10. Note that the GNSS receiver 3 and map database 4 may be built into the navigation device 5.

The actuators 6 make the vehicle 20 operate. For example, the actuators 6 include drive devices for accelerating the vehicle 20 (at least one of an engine and a motor), a brake actuator for braking the vehicle 20, a steering motor for steering the vehicle 20, etc. The ECU 10 controls the actuators 6 for the purpose of autonomous driving of the vehicle 20.

The display device 7 has a display for displaying text, images, and other digital information and presents various information to the driver of the vehicle 20. The display device 7 is provided at the inside of the vehicle so as to be able to be seen by the driver of the vehicle 20. The display device 7 is a human-machine interface (HMI) comprised of at least one of, for example, a touch screen, a heads up display, a digital instrumentation panel, etc. Note that, the display device 7 may be provided with a speaker for generating voice and other audio, operating buttons for a driver to perform input operations, a microphone receiving voice information from the driver, etc.

The ECU 10 performs various controls of the vehicle. As shown in FIG. 1, the ECU 10 is provided with a communication interface 11, a memory 12, and a processor 13. The communication interface 11 and the memory 12 are connected to the processor 13 through signal lines. Note that, in the present embodiment, a single ECU 10 is provided, but a plurality of ECUs may be provided for the respective functions.

The communication interface 11 has an interface circuit for connecting the ECU 10 to an internal vehicle network. The ECU 10 communicates with the vehicle detection device 2, the GNSS receiver 3, the map database 4, the navigation device 5, the actuators 6, and the display device 7 through the communication interface 11.

The memory 12, for example, has a volatile semiconductor memory and a nonvolatile semiconductor memory. The memory 12 stores programs, data, etc., used when various types of processing are performed by the processor 13.

The processor 13 has one or more CPUs (central processing units) and their peripheral circuits. Note that, the processor 13 may further have a processing circuit such as a logic processing unit or a numerical processing unit.

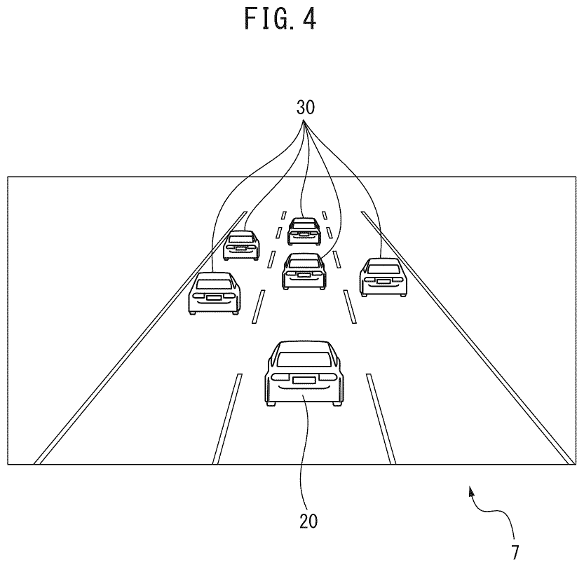

FIG. 3 is a functional block diagram of the ECU 10 of FIG. 1. In the present embodiment, the ECU 10 has a display control part 15, a vehicle control part 16 and a targeted vehicle setting part 17. The display control part 15, the vehicle control part 16 and the targeted vehicle setting part 17 are functional modules realized by programs stored in the memory 12 of the ECU 10 run by the processor 13 of the ECU 10.

The display control part 15 controls the display content of the display device 7. In the present embodiment, the display device 7 displays the vehicle 20 and surrounding vehicles in the surroundings of the vehicle 20 along with a driving lane and an adjacent lane of the vehicle 20. The surrounding vehicles in the surroundings of the vehicle 20 are detected by the vehicle detection device 2. The shape of the driving lane of the vehicle 20 and the shape and number of adjacent lanes are identified from the map information stored in the map database 4. That is, the display control part 15 acquires map information corresponding to the current location of the vehicle 20 identified based on the output of GNSS receiver 3, etc. from the map database 4. Note that the driving lane and adjacent lanes of the vehicle 20 may be detected by the vehicle detection device 2.

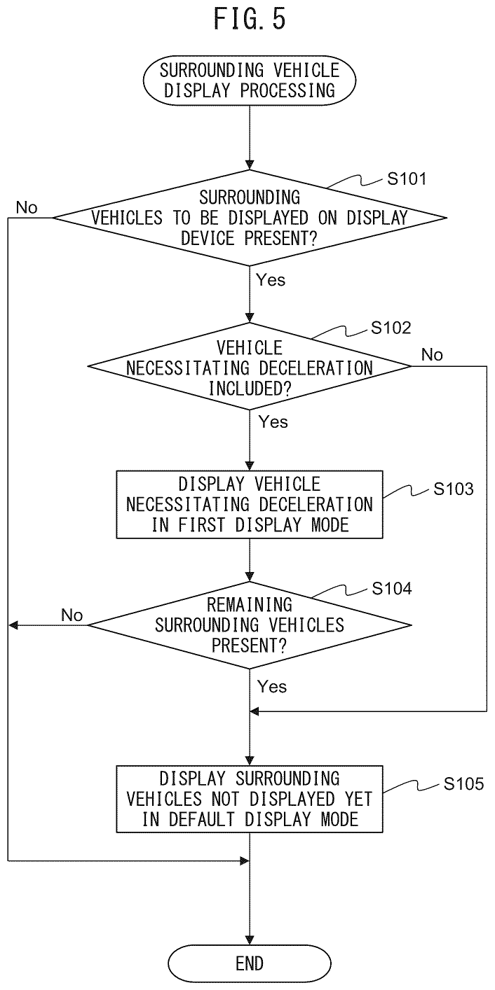

FIG. 4 is a view showing one example of an image displayed by the display device 7. As shown in FIG. 4, the display device 7 displays the vehicle 20 (host vehicle) and surrounding vehicles 30 as vehicle icons, respectively. The sizes and shapes of the vehicle icons are determined in advance.

As shown in FIG. 4, the display device 7 displays an image when seen from the rear of the vehicle 20 at a higher position than the vehicle 20. If there are a plurality of surrounding vehicles near the vehicle 20, the display control part 15 displays the plurality of surrounding vehicles detected by the vehicle detection device 2 on the display device 7. The driver of the vehicle 20 can view this display to thereby obtain a grasp of the detected state of the surrounding vehicles 30 in the surroundings of the vehicle 20 and in turn confirm the state of action in autonomous driving by the vehicle 20.

When autonomous driving of the vehicle 20 is performed, the vehicle control part 16 uses the actuators 6 to control the autonomous driving of the vehicle 20. For example, the vehicle control part 16 uses the actuators 6 to control steering, acceleration, and deceleration of the vehicle 20 and thereby perform an autonomous lane change of the vehicle 20.

The targeted vehicle setting part 17 sets a vehicle necessitating deceleration from among the surrounding vehicles detected by the vehicle detection device 2. Note that in the Description, “vehicle necessitating deceleration” means a surrounding vehicle restricting the speed of the vehicle 20 (host vehicle) due to its behavior.

First, the targeted vehicle setting part 17 sets a preceding vehicle in the driving lane of the vehicle 20 and a surrounding vehicle in an adjacent lane likely to enter the driving lane in front of the vehicle 20 as candidates for deceleration. At this time, whether the surrounding vehicle in the adjacent lane is likely to enter the driving lane in front of the vehicle 20 is judged based on, for example, the lateral speed of the surrounding vehicle. In this case, when, for example, the lateral speed of the surrounding vehicle in the direction by which the surrounding vehicle approaches the driving lane of the vehicle 20 is equal to or greater than a predetermined value, it is judged that the surrounding vehicle in the adjacent lane is likely to enter the driving lane in front of the vehicle 20. Further, if an obstacle (fallen object, broken down vehicle, construction site, etc.) is detected in front of the surrounding vehicle in the adjacent lane based on the output of the vehicle detection device 2, etc., it is judged that the surrounding vehicle in the adjacent lane is likely to enter the driving lane in front of the vehicle 20. Further, if a lane reduction will cause the adjacent lane to disappear and the driving lane of the vehicle 20 to become a merged lane, it is judged that the surrounding vehicle in the adjacent lane is likely to enter the driving lane in front of the vehicle 20.

Next, the targeted vehicle setting part 17 sets a vehicle necessitating deceleration among the candidates for deceleration based on a predetermined condition. For example, the targeted vehicle setting part 17 uses a map, etc. to judge whether a candidate for deceleration meets the requirement of a vehicle necessitating deceleration based on the distance between the vehicle 20 and the candidate for deceleration and the relative speed between the vehicle 20 and the candidate for deceleration. Further, if the driving lane of the vehicle 20 will become a merged lane, the targeted vehicle setting part 17 uses a requirement set so that the distance between the vehicle 20 and the candidate for deceleration in the adjacent lane becomes equal to or greater than a predetermined distance at a predetermined point before the merging to judge whether the candidate for deceleration in the adjacent lane meets the requirement of a vehicle necessitating deceleration. Note that, if a plurality of candidates for deceleration meet the requirement of a vehicle necessitating deceleration, the candidate for deceleration where the amount of restriction of the speed of the vehicle 20 (for example, the degree of deceleration of the vehicle 20) becomes the greatest is set as a vehicle necessitating deceleration. On the other hand, if there is no surrounding vehicle meeting the requirement of a vehicle necessitating deceleration present, no vehicle necessitating deceleration is set.

When a vehicle necessitating deceleration is set by the targeted vehicle setting part 17, the vehicle control part 16 controls acceleration and deceleration of the vehicle 20 so that the vehicle 20 will not approach the vehicle necessitating deceleration. Specifically, the vehicle control part 16 decelerates the vehicle 20 or suppresses acceleration of the vehicle 20 to a target speed so that the vehicle 20 does not approach the vehicle necessitating deceleration.

Therefore, the control of the vehicle 20 changes depending on the presence of any vehicle necessitating deceleration. For this reason, it is desirable that a person monitoring autonomous driving such as the driver of the vehicle 20 be able to quickly grasp the set state of a vehicle necessitating deceleration. However, when a plurality of surrounding vehicles in the surroundings of the vehicle 20 are displayed on the display device 7, it is difficult to differentiate a vehicle necessitating deceleration among the plurality of surrounding vehicles.

In this regard, in the present embodiment, when a plurality of surrounding vehicles detected by the vehicle detection device 2 are displayed on the display device 7, the display control part 15 displays the vehicle icon of a vehicle necessitating deceleration in a display mode different from the vehicle icons of the remaining surrounding vehicles. Due to this, even if a plurality of surrounding vehicles present in the surroundings of the host vehicle are displayed on the display device 7, it is easy to differentiate a vehicle necessitating deceleration on the display device 7.

Specifically, the display control part 15 displays the vehicle icon of a vehicle necessitating deceleration in a first display mode and displays the vehicle icons of the remaining surrounding vehicles in a default display mode. Therefore, when a surrounding vehicle displayed on the display device 7 is set as a vehicle necessitating deceleration, the display control part 15 changes the display mode of the vehicle icon of the surrounding vehicle set as a vehicle necessitating deceleration from the default display mode to the first display mode. The first display mode and the default display mode have mutually different transparency, luminance, color (hue), color brightness, color saturation, etc.

In particular, in the present embodiment, the display control part 15 displays the vehicle icon of a vehicle necessitating deceleration so that the vehicle necessitating deceleration is emphasized the most among the plurality of surrounding vehicles displayed on the display device 7. Due to this, it becomes easier to visually differentiate a vehicle necessitating deceleration on the display device 7. In this case, for example, the first display mode is set to a color different from the background color of the display device 7, and the default display mode is set to the same color as the background color of the display device 7. Specifically, the first display mode is set to amber or white, while the default display mode is set to light blue when the background color is blue (for example, when the driver gripping the steering wheel is not demanded) or is set to light gray when the background color is gray (for example, when the driver gripping the steering wheel is demanded). Note that the transparency of the first display mode may be made lower than the transparency of the default display mode, or the brightness of the first display mode may be made higher than the brightness of the default display mode. Further, the first display mode and default display mode may be set to the same color and the color saturation of the first display mode may be made higher than the color saturation of the default display mode.

Further, in the present embodiment, the display control part 15 displays the surrounding vehicles and the host vehicle (vehicle 20) on the display device 7. At this time, the display control part 15 displays the vehicle icon of the host vehicle in a display mode different from that of the vehicle icons of all surrounding vehicles displayed on the display device 7. By doing this, it becomes easy to differentiate between the host vehicle and the surrounding vehicles on the display device 7. For example, the vehicle icon of the host vehicle is displayed in black on the display device 7.

### <Surrounding Vehicle Display Processing>

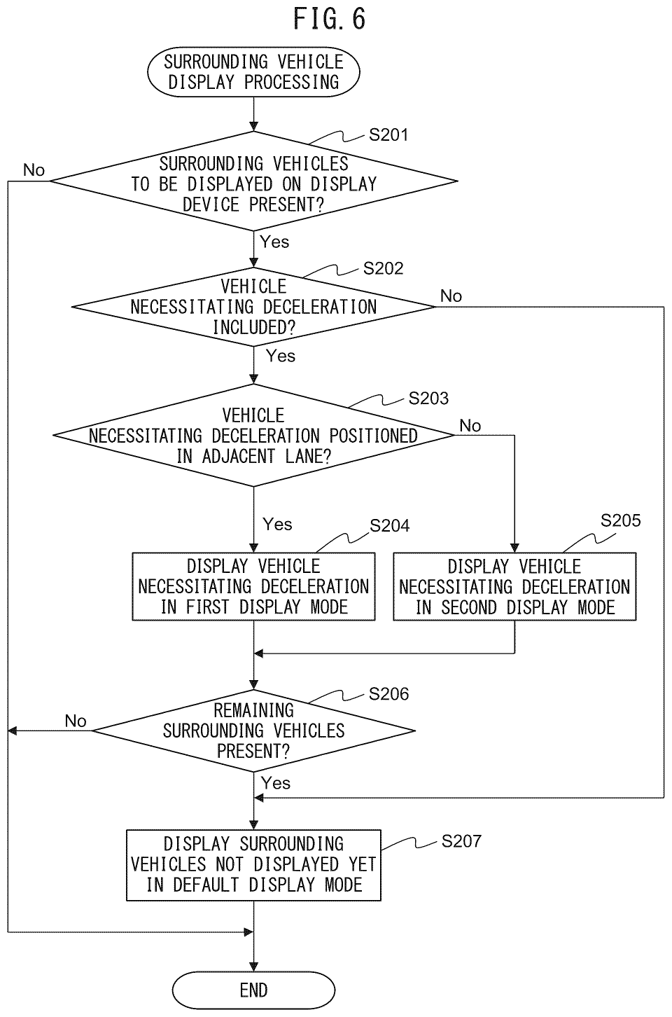

Below, the flow chart of FIG. 5 will be used to explain the above-mentioned control. FIG. 5 is a flow chart showing a control routine of surrounding vehicle display processing in the first embodiment. The present control routine is repeatedly executed by the ECU 10 at predetermined intervals. The predetermined intervals are, for example, intervals at which the results of detection of surrounding vehicles by the vehicle detection device 2 are updated.

First, at step S101, the display control part 15 judges whether surrounding vehicles to be displayed on the display device 7 are present. The surrounding vehicles to be displayed on the display device 7 are selected from among the surrounding vehicles detected by the vehicle detection device 2. For example, a surrounding vehicle which is positioned in front of the host vehicle in the driving lane or an adjacent lane of the host vehicle and has a relative distance to the host vehicle of equal to or less than a predetermined distance is selected as the surrounding vehicle to be displayed on the display device 7. Note that surrounding vehicle positioned in the vicinity behind the host vehicle may also be selected as the surrounding vehicle to be displayed on the display device 7.

If at step S101 it is judged that no surrounding vehicle to be displayed on the display device 7 is present, the present control routine ends. On the other hand, if at step S101 if it is judged that at least one surrounding vehicle to be displayed on the display device 7 is present, the present control routine proceeds to step S102.

At step S102, the display control part 15 judges whether the surrounding vehicles to be displayed on the display device 7 include a vehicle necessitating deceleration. In other words, the display control part 15 judges whether one of the surrounding vehicles to be displayed on the display device 7 is set as a vehicle necessitating deceleration. If it is judged that a vehicle necessitating deceleration is included, the present control routine proceeds to step S103.

At step S103, the display control part 15 displays the vehicle icon of a vehicle necessitating deceleration in the first display mode on the display device 7. At this time, if a vehicle necessitating deceleration is positioned in the driving lane of the host vehicle, the vehicle icon of the vehicle necessitating deceleration is displayed in the driving lane, while if a vehicle necessitating deceleration is positioned in an adjacent lane of the host vehicle, the vehicle icon of the vehicle necessitating deceleration is displayed in the adjacent lane. Further, if a surrounding vehicle which had been displayed on the display device 7 is set as a vehicle necessitating deceleration, the display mode of the vehicle icon of this surrounding vehicle is changed from the default display mode to the first display mode.

Next, at step S104, the display control part 15 judges whether there are remaining surrounding vehicles besides a vehicle necessitating deceleration among the vehicles to be displayed on the display device 7. If it is judged that no remaining surrounding vehicle is present, the present control routine ends. On the other hand, if it is judged that ate least one remaining surrounding vehicle is present, the present control routine proceeds to step S105.

At step S105, the display control part 15 displays the vehicle icons of the surrounding vehicles which have not displayed yet among the surrounding vehicles to be displayed on the display device 7, in this case, the vehicle icons of the remaining surrounding vehicles besides the vehicle necessitating deceleration, on the display device 7 in the default display mode. After step S105, the present control routine ends.

On the other hand, if at step S102 it is judged that no vehicle necessitating deceleration is included, the present control routine skips steps S103 and S104 and proceeds to step S105. At step S105, the display control part 15 displays the vehicle icons of the surrounding vehicles which have not displayed yet among the surrounding vehicles to be displayed on the display device 7, in this case the vehicle icons of all surrounding vehicles to be displayed on the display device 7, on the display device 7 in the default display mode. After step S105, the present control routine ends.

### Second Embodiment

An autonomous driving system according to a second embodiment is basically the same as the autonomous driving system according to the first embodiment in configuration and control except for the points explained below. For this reason, below, the second embodiment of the present disclosure will be explained focusing on parts different from the first embodiment.

Usually, a person monitoring autonomous driving, like the driver, will tend to pay more attention to a preceding vehicle in the driving lane of the host vehicle than a preceding vehicle in an adjacent lane of the host vehicle. Considering this, in the second embodiment, when a vehicle necessitating deceleration is present in an adjacent lane of the host vehicle, compared to when a vehicle necessitating deceleration is in the driving lane of the host vehicle, the display control part 15 displays the vehicle icon of the vehicle necessitating deceleration so that the vehicle necessitating deceleration is emphasized. Due to this, even if the person monitoring autonomous driving had been paying attention to a preceding vehicle in the driving lane of the host vehicle, it is possible to draw attention to a vehicle necessitating deceleration when a vehicle necessitating deceleration appears in an adjacent lane.

Specifically, the display control part 15 displays the vehicle icon of a vehicle necessitating deceleration in an adjacent lane of the host vehicle in the first display mode, displays the vehicle icon of a vehicle necessitating deceleration in the driving lane of the host vehicle in the second display mode, and displays the vehicle icons of the remaining surrounding vehicles to be displayed in the default display mode. The first display mode, the second display mode, and the default display mode for example have mutually different transparency, luminance, color (hue), color brightness, color saturation, etc.

For example, the first display mode is set to a chromatic color different from the background color of the display device 7, the second display mode is set to an achromatic color (white, black, or gray) different from the background color of the display device 7, and the default display mode is set to the same color as the background color of the display device 7. Specifically, the first display mode is set to amber, the second display mode is set to white, and the default display mode is set to light blue when the background color is blue (for example, when the driver gripping the steering wheel is not demanded) or set to light gray when the background color is gray (for example, when the driver gripping the steering wheel is demanded). Note that the transparency of the vehicle icon may be made lower or the luminance of the vehicle icon may made higher in the order of the default display mode, the second display mode, and the first display mode. Further, the first display mode, the second display mode, and the default display mode may be set to the same color and the saturation of the color of the vehicle icon may be made higher in the order of the default display mode, the second display mode, and the first display mode.

### <Surrounding Vehicle Display Processing>

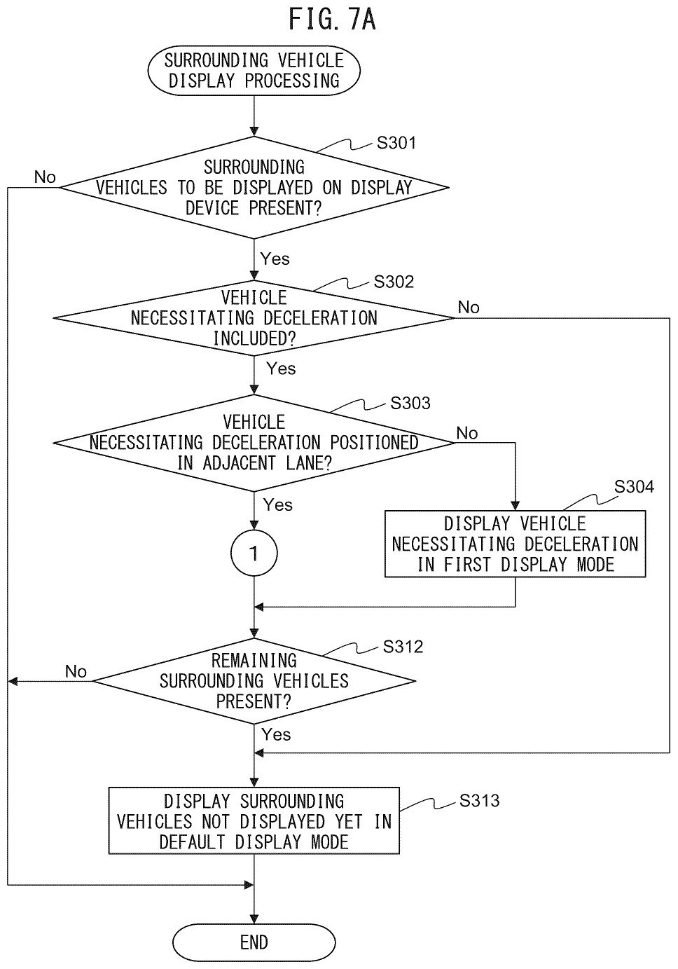

Below, the flow chart of FIG. 6 will be used to explain the above-explained control in detail. FIG. 6 is a flow chart showing a control routine for surrounding vehicle display processing in the second embodiment. The present control routine is repeatedly executed by the ECU 10 at predetermined intervals. The predetermined intervals are, for example, intervals at which the results of detection of the surrounding vehicles by the vehicle detection device 2 are updated.

First, at step S201, in the same way as step S101 of FIG. 5, the display control part 15 judges whether surrounding vehicles to be displayed on the display device 7 are present. If it is judged that no surrounding vehicle to be displayed on the display device 7 is present, the present control routine ends. On the other hand, if it is judged that ate least one surrounding vehicle to be displayed on the display device 7 is present, the present control routine proceeds to step S202. At step S202, in the same way as step S102 of FIG. 5, the display control part 15 judges whether the surrounding vehicles to be displayed on the display device 7 include a vehicle necessitating deceleration. If it is judged that a vehicle necessitating deceleration is included, the present control routine proceeds to step S203.

At step S203, the display control part 15 judges whether a vehicle necessitating deceleration is positioned in an adjacent lane of the host vehicle. In other words, the display control part 15 judges whether a surrounding vehicle in an adjacent lane of the host vehicle is set as a vehicle necessitating deceleration.

If at step S203 it is judged that a vehicle necessitating deceleration is positioned in the adjacent lane, the present control routine proceeds to step S204. At step S204, the display control part 15 displays the vehicle icon of the vehicle necessitating deceleration in the adjacent lane in the first display mode on the display device 7. At this time, when a surrounding vehicle in the adjacent lane which had been displayed on the display device 7 is set as a vehicle necessitating deceleration, the display mode of this surrounding vehicle is changed from the default display mode to the first display mode.

On the other hand, if at step S203 it is judged that no vehicle necessitating deceleration is positioned in an adjacent lane, that is, if it is judged that a vehicle necessitating deceleration is positioned in the driving lane of the host vehicle, the present control routine proceeds to step S205. At step S205, the display control part 15 displays the vehicle icon of a vehicle necessitating deceleration in the driving lane of the host vehicle in the second display mode on the display device 7. At this time, if a surrounding vehicle in the driving lane of the host vehicle which had been displayed on the display device 7 is set as a vehicle necessitating deceleration, the display mode of this surrounding vehicle is changed from the default display mode to the second display mode.

After step S204 or step S205, the present control routine proceeds to step S206. At step S206, in the same way as step S104 of FIG. 5, it is judged whether there are remaining surrounding vehicles to be displayed on the display device 7 besides a vehicle necessitating deceleration. If it is judged that no remaining surrounding vehicle is present, the present control routine ends. On the other hand, if it is judged that at least one remaining surrounding vehicle is present, the present control routine proceeds to step S207.

At step S207, in the same way as step S105 of FIG. 5, the display control part 15 displays the vehicle icons of the surrounding vehicles which have not displayed yet among the surrounding vehicles to be displayed on the display device 7, in this case, the vehicle icons of the remaining surrounding vehicles besides a vehicle necessitating deceleration, in the default display mode on the display device 7. After step S207, the present control routine ends.

On the other hand, if at step S202 it is judged that a vehicle necessitating deceleration is not included, the present control routine skips steps S203 to S206 and proceeds to step S207. At step S207, in the same way as step S105 of FIG. 5, the display control part 15 displays the vehicle icons of the surrounding vehicles which have not displayed yet among the surrounding vehicles to be displayed on the display device 7, in this case the vehicle icons of all other vehicles to be displayed on the display device 7, in the default display mode on the display device 7. After step S207, the present control routine ends.

### Third Embodiment

An autonomous driving system according to a third embodiment is basically the same as the autonomous driving system according to the first embodiment in configuration and control except for the points explained below. For this reason, below, the third embodiment of the present disclosure will be explained focusing on parts different from the first embodiment.

In a driving environment in which a plurality of surrounding vehicles are present near the host vehicle, the set of vehicle necessitating deceleration is frequently switched. For this reason, if the presence of any set vehicle necessitating deceleration is constantly displayed on the display device 7, the display on the display device 7 becomes complicated. Further, if a surrounding vehicle in an adjacent lane is set as a vehicle necessitating deceleration, the degree of influence on the host vehicle differs depending on the presence of any preceding vehicle in the driving lane of the host vehicle and the position of the vehicle necessitating deceleration.

Therefore, in the third embodiment, when a vehicle necessitating deceleration is positioned in an adjacent lane of the host vehicle and a preceding vehicle is detected in the driving lane of the host vehicle, if the distance between the host vehicle and a vehicle necessitating deceleration is shorter than the distance between the host vehicle and the preceding vehicle, the display control part 15 displays a vehicle necessitating deceleration in a display mode different from the vehicle icons of the remaining surrounding vehicles. On the other hand, when a vehicle necessitating deceleration is positioned in an adjacent lane of the host vehicle and no preceding vehicle is detected in the driving lane of the host vehicle, if the distance between the host vehicle and a vehicle necessitating deceleration is shorter than a predetermined distance, the display control part 15 displays a vehicle necessitating deceleration in a display mode different from the vehicle icons of the remaining surrounding vehicle. As a result, it is possible to draw attention to a vehicle necessitating deceleration when there is the high possibility that a vehicle necessitating deceleration in an adjacent lane will influence the acceleration/deceleration control of the host vehicle and keep the display on the display device 7 from becoming complicated.

### <Surrounding Vehicle Display Processing>

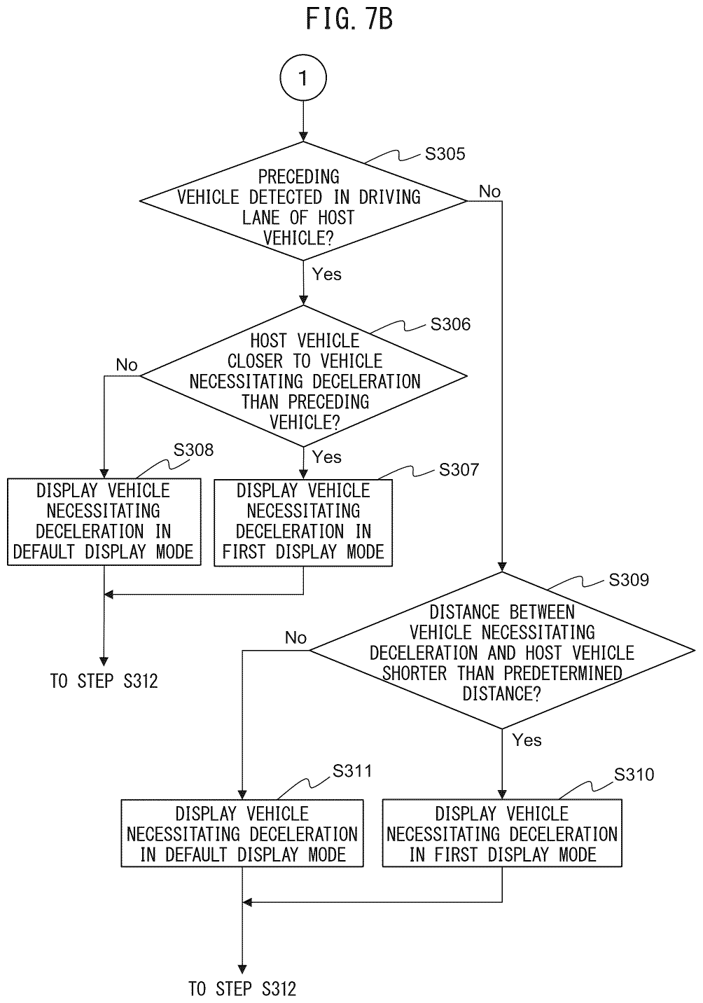

Below, the flow charts of FIG. 7A and FIG. 7B will be used to explain the above-explained control in detail. FIG. 7A and FIG. 7B are flow charts showing a control routine for surrounding vehicle display processing in the third embodiment. The present control routine is repeatedly executed by the ECU 10 at predetermined intervals. The predetermined intervals are, for example, intervals at which the results of detection of the surrounding vehicles by the vehicle detection device 2 are updated.

First, at step S301, in the same way as step S101 of FIG. 5, the display control part 15 judges whether surrounding vehicles to be displayed on the display device 7 are present. If it is judged that no surrounding vehicle to be displayed on the display device is present, the present control routine ends. On the other hand, if it is judged that at least one surrounding vehicle to be displayed on the display device 7 is present, the present control routine proceeds to step S302.

At step S302, in the same way as step S102 of FIG. 5, the display control part 15 judges whether the surrounding vehicles to be displayed on the display device 7 include a vehicle necessitating deceleration. If it is judged that a vehicle necessitating deceleration is included, the present control routine proceeds to step S303.

At step S303, the display control part 15 judges whether a vehicle necessitating deceleration is positioned in an adjacent lane of the host vehicle. In other words, the display control part 15 judges whether a surrounding vehicle in an adjacent lane of the host vehicle is set as a vehicle necessitating deceleration.

When at step S303 it is judged that a vehicle necessitating deceleration is not positioned in an adjacent lane, that is, when it is judged that a vehicle necessitating deceleration is positioned in the driving lane of the host vehicle, the present control routine proceeds to step S304. At step S304, the display control part 15 displays the vehicle icon of a vehicle necessitating deceleration in the driving lane of the host vehicle in the first display mode on the display device 7.

On the other hand, if at step S303 it is judged that a vehicle necessitating deceleration is positioned in an adjacent lane, the present control routine proceeds to step S305. At step S305, the display control part 15 judges whether a preceding vehicle has been detected in the driving lane of the host vehicle by the vehicle detection device 2. If it is judged that a preceding vehicle has been detected in the driving lane of the host vehicle, the present control routine proceeds to step S306.

At step S306, the display control part 15 judges whether the host vehicle is closer to a vehicle necessitating deceleration than the preceding vehicle. That is, the display control part 15 judges whether the distance between the host vehicle and a vehicle necessitating deceleration is shorter than the distance between the host vehicle and the preceding vehicle. The distance between two vehicles is, for example, the following distance in the direction of advance of the host vehicle or the distance between the center coordinates of two vehicles. Note that, when a plurality of preceding vehicles are present in the driving lane of the host vehicle, as the distance between the host vehicle and the preceding vehicle, the distance between the host vehicle and the preceding vehicle closest to the host vehicle (the first preceding vehicle explained later) is used.

If it is judged at step S306 that the host vehicle is closer to a vehicle necessitating deceleration than the preceding vehicle, the present control routine proceeds to step S307. At step S307, the display control part 15 displays the vehicle icon of a vehicle necessitating deceleration in the adjacent lane on the display device 7 in the first display mode. At this time, if a surrounding vehicle in the adjacent lane which had been displayed on the display device 7 is set as a vehicle necessitating deceleration, the display mode of this surrounding vehicle is changed from the default display mode to the first display mode.

On the other hand, if it is judged at step S306 that the host vehicle is not closer to a vehicle necessitating deceleration than the preceding vehicle, the present control routine proceeds to step S308. At step S308, the display control part 15 displays the vehicle icon of a vehicle necessitating deceleration in the adjacent lane on the display device 7 in the default display mode.

Further, if it is judged at step S305 that no preceding vehicle has been detected in the driving lane of the host vehicle, the present control routine proceeds to step S309. At step S309, the display control part 15 judges whether the distance between a vehicle necessitating deceleration and the host vehicle is shorter than a predetermined distance. As the distance between two vehicles, for example, the following distance in the direction of advance of the host vehicle or the distance between the center coordinates of two vehicles is used. The predetermined distance is set to, for example, a fixed value determined in advance. Note that the predetermined value may be set according to the following mode (for example, close following mode, intermediate following mode, or long following mode) set by the driver, etc., the speed of the host vehicle, etc.

If it is judged at step S309 that the distance between a vehicle necessitating deceleration and the host vehicle is shorter than the predetermined distance, the present control routine proceeds to step S310. At step S310, the display control part 15 displays the vehicle icon of a vehicle necessitating deceleration in the adjacent lane in the first display mode on the display device 7. At this time, when a surrounding vehicle in the adjacent lane which had been displayed in the display device 7 is set as a vehicle necessitating deceleration, the display mode of this surrounding vehicle is changed from the default display mode to the first display mode.

On the other hand, if it is judged at step S309 that the distance between a vehicle necessitating deceleration and the host vehicle is equal to or greater than the predetermined distance, the present control routine proceeds to step S311. At step S311, the display control part 15 displays the vehicle icon of a vehicle necessitating deceleration in the adjacent lane in the default display mode on the display device 7.

After step S304, S307, S308, S310, or S311, the present control routine proceeds to step S312. At step S312, in the same way as step S104 of FIG. 5, it is judged whether there are at least one remaining surrounding vehicle besides a vehicle necessitating deceleration among the vehicles to be displayed on the display device 7. If it is judged that no remaining surrounding vehicle is present, the present control routine ends. On the other hand, if it is judged that remaining surrounding vehicles are present, the present control routine proceeds to step S313.

At step S313, in the same way as step S105 of FIG. 5, the display control part 15 displays the vehicle icons of the surrounding vehicles which have not displayed yet among the surrounding vehicles to be displayed on the display device 7, in this case, the vehicle icons of the remaining surrounding vehicles besides a vehicle necessitating deceleration, in the default display mode on the display device 7. After step S313, the present control routine ends.

On the other hand, if it is judged at step S302 that a vehicle necessitating deceleration is not included, the present control routine skips steps S303 to S312 and proceeds to step S313. At step S313, in the same way as step S105 of FIG. 5, the display control part 15 displays the vehicle icons of the surrounding vehicles which have not displayed among the surrounding vehicles to be displayed on the display device 7, in this case, the vehicle icons of all of the other vehicles to be displayed on the display device 7, in the default display mode on the display device 7. After step S313, the present control routine ends.

### Fourth Embodiment

An autonomous driving system according to a fourth embodiment is basically the same as the autonomous driving system according to the first embodiment in configuration and control except for the points explained below. For this reason, below, the fourth embodiment of the present disclosure will be explained focusing on parts different from the first embodiment.

It is desirable that a person monitoring autonomous driving, like the driver, basically pay attention to a preceding vehicle positioned right in front in the driving lane of the host vehicle when a vehicle necessitating deceleration is not present. Therefore, in the fourth embodiment, the display control part 15 displays the vehicle icon of a first preceding vehicle positioned in front of the host vehicle in the driving lane of the host vehicle and closest to the host vehicle in a display mode different from that of the vehicle icons of the remaining surrounding vehicles. Due to this, even if a plurality of surrounding vehicles present in the surroundings of the host vehicle are displayed on the display device 7, it is easy to differentiate the first preceding vehicle on the display device 7.

Specifically, the display control part 15 displays the vehicle icon of a vehicle necessitating deceleration in an adjacent lane of the host vehicle in the first display mode, displays the vehicle icon of the first preceding vehicle in the second display mode, and displays the vehicle icons of the remaining surrounding vehicles in the default display mode. Accordingly, the display control part 15 displays the vehicle icon of the first preceding vehicle in the second display mode regardless of whether the first preceding vehicle is a vehicle necessitating deceleration. On the other hand, when a surrounding vehicle in an adjacent lane which has been displayed on the display device 7 is set as a vehicle necessitating deceleration, the display control part 15 changes the display mode of the vehicle icon of the surrounding vehicle in the adjacent lane set as a vehicle necessitating deceleration from the default display mode to the first display mode. The first display mode, the second display mode, and the default display mode for example have mutually different transparency, luminance, color (hue), color brightness, color saturation, etc.

In particular, in the fourth embodiment, the display control part 15 displays the vehicle icon of a first preceding vehicle so that the first preceding vehicle is emphasized more than the surrounding vehicles besides a vehicle necessitating deceleration. Due to this, it is possible to draw attention to a vehicle necessitating deceleration when there is a vehicle necessitating deceleration and to draw attention to a first preceding vehicle when there is no vehicle necessitating deceleration.

In this case, for example, the first display mode is set to a chromatic color different from the background color of the background color of the display device 7, the second display mode is set to an achromatic color (white, black, or gray) different from the background color of the display device 7, and the default display mode is set to the same color as the background color of the display device 7. Specifically, the first display mode is set to amber, the second display mode is set to white, and the default display mode is set to light blue when the background color is blue (for example, when the driver gripping the steering wheel is not demanded) or set to light gray when the background color is gray (for example, when the driver gripping the steering wheel is demanded). Note that the transparency of the vehicle icon may be made lower or the luminance of the vehicle icon may made higher in the order of the default display mode, the second display mode, and the first display mode. Further, the first display mode, the second display mode, and the default display mode may be set to the same color and the saturation of the color of the vehicle icon may be made higher in the order of the default display mode, the second display mode, and the first display mode.

### <Surrounding Vehicle Display Processing>

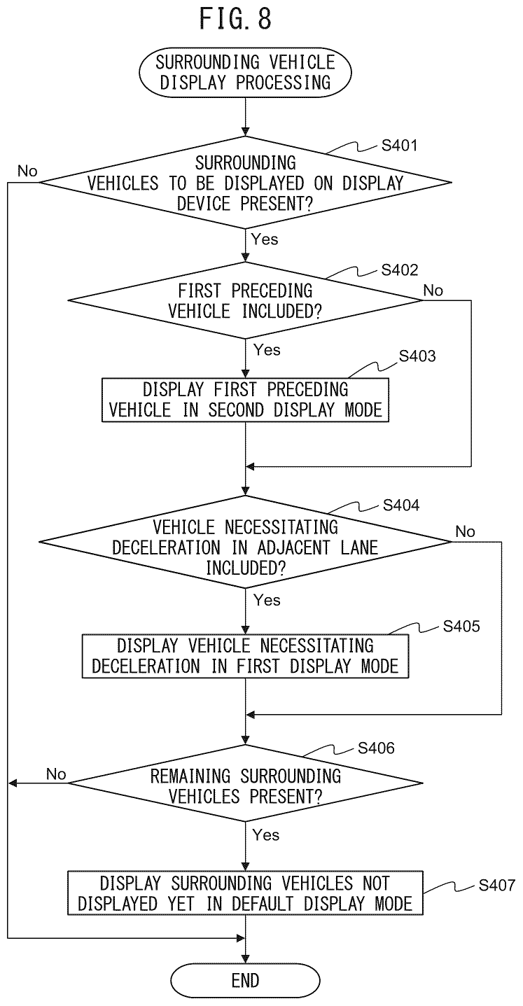

Below, the flow chart of FIG. 8 will be used to explain the above-explained control in detail. FIG. 8 is a flow chart showing a control routine for surrounding vehicle display processing in the fourth embodiment. The present control routine is repeatedly executed by the ECU 10 at predetermined intervals. The predetermined intervals are, for example, intervals at which the results of detection of the surrounding vehicles by the vehicle detection device 2 are updated.

First, at step S401, in the same way as step S101 of FIG. 5, the display control part 15 judges whether surrounding vehicles to be displayed on the display device 7 are present. If it is judged that no surrounding vehicles to be displayed on the display device 7 are present, the present control routine ends. On the other hand, if it is judged that surrounding vehicles to be displayed on the display device 7 are present, the present control routine proceeds to step S402.

At step S402, the display control part 15 judges whether the surrounding vehicles to be displayed on the display device 7 include a first preceding vehicle. If it is judged that a first preceding vehicle is included, the present control routine proceeds to step S403.

At step S403, the display control part 15 displays the vehicle icon of the first preceding vehicle in the second display mode on the display device 7. After step S403, the present control routine proceeds to step S404. On the other hand, if at step S402 it is judged that a first preceding vehicle is not included, the present control routine skips step S403 and proceeds to step S404.

At step S404, the display control part 15 judges whether the surrounding vehicles to be displayed on the display device 7 include a vehicle necessitating deceleration in an adjacent lane of the host vehicle. If it is judged that a vehicle necessitating deceleration in an adjacent lane is included, the present control routine proceeds to step S405.

At step S405, the display control part 15 displays the vehicle icon of a vehicle necessitating deceleration in the adjacent lane on the display device 7 in the first display mode. At this time, if a surrounding vehicle in an adjacent lane which had been displayed on the display device 7 is set as a vehicle necessitating deceleration, the display mode of this surrounding vehicle is changed from the default display mode to the first display mode. After step S405, the present control routine proceeds to step S406. On the other hand, if at step S404 it is judged that a vehicle necessitating deceleration in an adjacent lane is not included, the present control routine skips step S405 and proceeds to step S406.

At step S406, the display control part 15 judges whether there is at least one remaining surrounding vehicle remaining besides the first preceding vehicle and a vehicle necessitating deceleration among the vehicles to be displayed on the display device 7. If it is judged that no remaining surrounding vehicle is present, the present control routine ends. On the other hand, if it is judged that remaining surrounding vehicles are present, the present control routine proceeds to step S407.

At step S407, the display control part 15 displays on the display device 7 the vehicle icons of the surrounding vehicles which have not displayed yet among the surrounding vehicles to be displayed on the display device 7 in the default display mode. After step S407, the present control routine ends.

### Fifth Embodiment

An autonomous driving system according to a fifth embodiment is basically the same as the autonomous driving system according to the fourth embodiment in configuration and control except for the points explained below. For this reason, below, the fifth embodiment of the present disclosure will be explained focusing on parts different from the fourth embodiment.

The degree of influence of the first preceding vehicle on the host vehicle differs according to the position of the first preceding vehicle. Therefore, in the fifth embodiment, the display control part 15 displays the vehicle icon of the first preceding vehicle in a display mode different from the vehicle icons of the remaining surrounding vehicles if the distance between the first preceding vehicle and the host vehicle is shorter than a predetermined distance. Due to this, it is possible to draw attention to the first preceding vehicle when there is a high possibility that the first preceding vehicle will influence the acceleration/deceleration control of the host vehicle and to reduce the monitoring burden on the person monitoring the autonomous driving.

### <Surrounding Vehicle Display Processing>

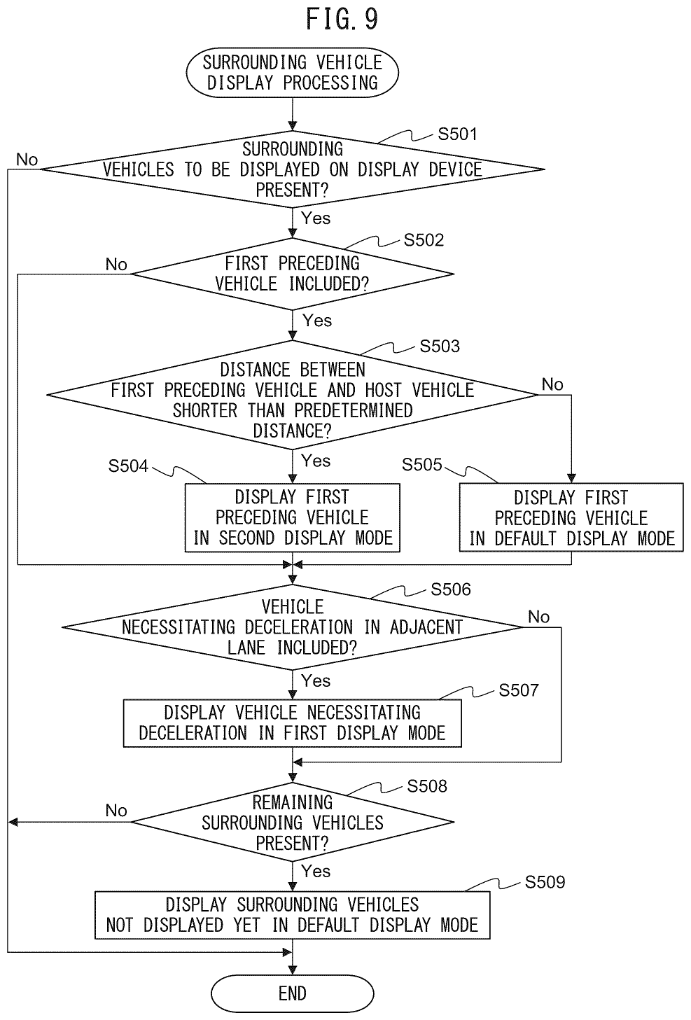

Below, the flow chart of FIG. 9 will be used to explain the above-explained control in detail. FIG. 9 is a flow chart showing a control routine for surrounding vehicle display processing in the fifth embodiment. The present control routine is repeatedly executed by the ECU 10 at predetermined intervals. The predetermined intervals are, for example, intervals at which the results of detection of the surrounding vehicles by the vehicle detection device 2 are updated.

First, at step S501, in the same way as step S401 of FIG. 8, the display control part 15 judges whether surrounding vehicles to be displayed on the display device 7 are present. If it is judged that no surrounding vehicles to be displayed on the display device 7 are present, the present control routine ends. On the other hand, if it is judged that surrounding vehicles to be displayed on the display device 7 are present, the present control routine proceeds to step S502.

At step S502, in the same way as step S402 of FIG. 8, the display control part 15 judges whether the surrounding vehicles to be displayed on the display device 7 include a first preceding vehicle. If it is judged that a first preceding vehicle is included, the present control routine proceeds to step S503.

At step S503, the display control part 15 judges whether the distance between the first preceding vehicle and the host vehicle is shorter than a predetermined distance. As the distance between two vehicles, for example, the following distance in the direction of advance of the host vehicle or the distance between the center coordinates of two vehicles is used. The predetermined distance is set to, for example, a fixed value determined in advance. Note that the predetermined value may be set according to the following mode (for example, close following mode, intermediate following mode, or long following mode) set by the driver, etc., the speed of the host vehicle, etc.

If it is judged at step S503 that the distance between the first preceding vehicle and the host vehicle is shorter than the predetermined distance, the present control routine proceeds to step S504. At step S504, the display control part 15 displays the vehicle icon of the first preceding vehicle in the second display mode on the display device 7.

On the other hand, if it is judged at step S503 that the distance between the first preceding vehicle and the host vehicle is equal to or greater than the predetermined distance, the present control routine proceeds to step S505. At step S505, the display control part 15 displays the vehicle icon of the first preceding vehicle in the default display mode on the display device 7.

After step S504 or step S505, the present control routine proceeds to step S506. On the other hand, if it is judged at step S502 that a first preceding vehicle is not included, the present control routine skips steps S503 to S505 and proceeds to step S506. Steps S506 to S509 are similar to steps S404 to S407 of FIG. 8, and therefore the explanations thereof are omitted.

### Sixth Embodiment

An autonomous driving system according to a sixth embodiment is basically the same as the autonomous driving system according to the fourth embodiment in configuration and control except for the points explained below. For this reason, below, the sixth embodiment of the present disclosure will be explained focusing on parts different from the fourth embodiment.

A vehicle control part 16 executes an autonomous lane change when the host vehicle arrives at a point of a lane change planned in advance in a driving plan (for example, a lane change for merging) or when a lane change is instructed by the driver through operation of a turn signal lever. When the lane change is started, the degree of influence on the host vehicle by a surrounding vehicle present in the lane after the lane change increases.

For this reason, in the sixth embodiment, when a lane change of the host vehicle is being executed by the vehicle control part 16, the vehicle control part 16 displays the vehicle icon of a surrounding vehicle positioned in front of the host vehicle in the lane after the lane change and closest to the host vehicle (below, referred to as “preceding vehicle after a lane change”) instead of the first preceding vehicle, in a display mode different from the vehicle icons of the remaining surrounding vehicles. Due to this, it is possible to make the driver recognize that the surrounding vehicle to which attention should be drawn has been changed due to the lane change.

### <Surrounding Vehicle Display Processing>

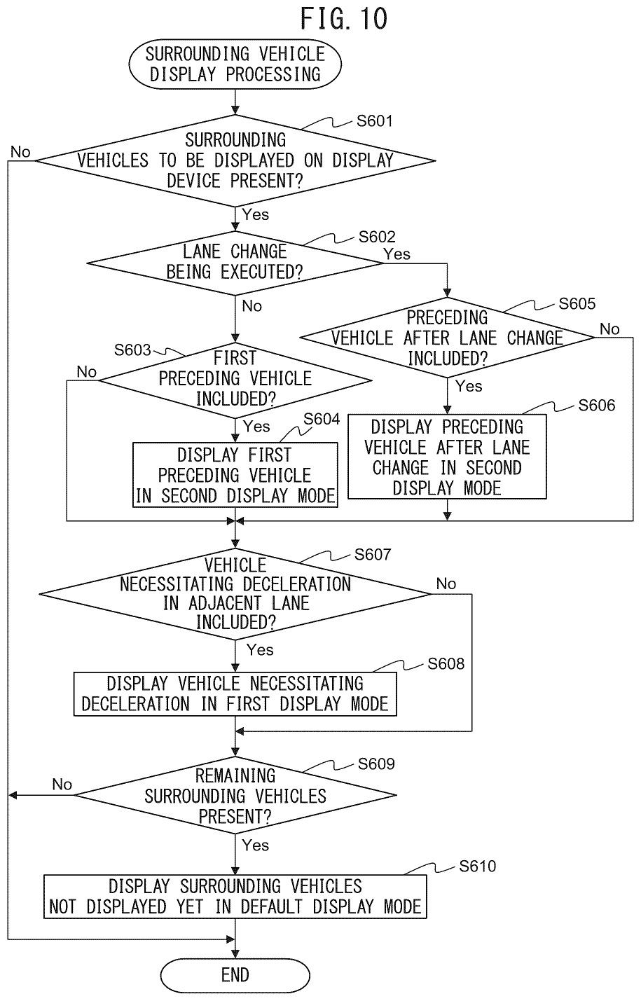

Below, the flow chart of FIG. 10 will be used to explain the above-explained control in detail. FIG. 10 is a flow chart showing a control routine for surrounding vehicle display processing in the sixth embodiment. The present control routine is repeatedly executed by the ECU 10 at predetermined intervals. The predetermined intervals are, for example, intervals at which the results of detection of the surrounding vehicles by the vehicle detection device 2 are updated.

First, at step S601, in the same way as step S401 of FIG. 8, the display control part 15 judges whether surrounding vehicles to be displayed on the display device 7 are present. If it is judged that no surrounding vehicle to be displayed on the display device 7 is present, the present control routine ends. On the other hand, if it is judged that surrounding vehicles to be displayed on the display device 7 are present, the present control routine proceeds to step S602.

At step S602, the display control part 15 judges whether a lane change is being executed by the vehicle control part 16. If it is judged that a lane change is not being executed, the present control routine proceeds to step S603.

At step S603, in the same way as step S402 of FIG. 8, the display control part 15 judges whether the surrounding vehicles to be displayed on the display device 7 include a first preceding vehicle. If it is judged that a first preceding vehicle is included, the present control routine proceeds to step S604.

At step S604, in the same way as step S403 of FIG. 8, the display control part 15 displays the vehicle icon of the first preceding vehicle in the second display mode on the display device 7. After step S604, the present control routine proceeds to step S607. On the other hand, if at step S603 it is judged that a first preceding vehicle is not included, the present control routine skips step S604 and proceeds to step S607.

Further, if at step S602 it is judged that lane change is being executed, the present control routine proceeds to step S605. At step S605, the display control part 15 judges whether the surrounding vehicles to be displayed on the display device 7 include a preceding vehicle after a lane change. If it is judged that a preceding vehicle after a lane change is included, the present control routine proceeds to step S606.

At step S606, the display control part 15 displays the preceding vehicle after a lane change in the second display mode on the display device 7. After step S606, the present control routine proceeds to step S607. On the other hand, if at step S605 it is judged that a preceding vehicle after a lane change is not included, the present control routine skips step S606 and proceeds to step S607.

Step S607 to step S610 are similar to steps S404 to S407 of FIG. 8, and therefore the explanations thereof are omitted.

Above, preferred embodiments according to the present disclosure were explained, but the present disclosure is not limited to these embodiments. Various corrections and changes can be made within the language of the claims. For example, only surrounding vehicles may be displayed on the display device 7, and the host vehicle (vehicle 20) may not be displayed on the display device 7.

Further, the display device 7 of the autonomous driving system 1 may be provided on a server at the outside of the vehicle 20, in addition to the vehicle 20 or instead of the vehicle 20, so that an operator can remotely monitor the autonomous driving of the vehicle 20. In this case, the output of the vehicle detection device 2, etc. is transmitted from the vehicle 20 to the server, and the processor of the server may function as the display control part and the targeted vehicle setting part. Further, such a server may be provided with a steering device, etc., for the operator to remotely control the autonomous driving of the vehicle 20.

Further, a plurality of types of vehicle icons may be used as the vehicle icon showing a surrounding vehicle. For example, the surrounding vehicle detected by the vehicle detection device 2 may be differentiated as a passenger car or a truck, and as the vehicle icon showing a surrounding vehicle, a vehicle icon for a passenger car and a vehicle icon for a truck may be used.

Further, the above embodiments can be worked in any combination. For example, if the second embodiment and the third embodiment are combined, at step S304 of FIG. 7A, in the same way as step S205 of FIG. 6, the display control part 15 displays the vehicle icon of a vehicle necessitating deceleration in the driving lane of the host vehicle in the second display mode on the display device 7. Further, if the fifth embodiment and the sixth embodiment are combined, in the control routine of FIG. 10, steps S502 to S505 of FIG. 9 are performed in place of steps S603 and S604.

### REFERENCE SIGNS LIST

1: autonomous driving system
2: vehicle detection device
7: display device
10: electronic control unit (ECU)
15: display control part
16: vehicle control part
17: targeted vehicle setting part
20: vehicle

1. An autonomous driving system comprising:
a vehicle detection device for detecting surrounding vehicles present in surroundings of a host vehicle;
a display device for displaying the surrounding vehicles detected by the vehicle detection device as vehicle icons; and
a processor configured to: control display content of the display device; control autonomous driving of the host vehicle; and set, as a vehicle necessitating deceleration, a surrounding vehicle present on an adjacent lane of the host vehicle and predicted to be entered into a driving lane of the host vehicle in front of the host vehicle among the surrounding vehicles detected by the vehicle detection device, wherein
the processor is configured to control acceleration and deceleration of the host vehicle so that the host vehicle does not approach the vehicle necessitating deceleration, and
when a plurality of surrounding vehicles detected by the vehicle detection device are displayed on the display device, the processor is configured to display a vehicle icon of the vehicle necessitating deceleration so that the vehicle necessitating deceleration is emphasized.

2. The autonomous driving system according to claim 1, wherein the processer is configured to display the vehicle icon of the vehicle necessitating deceleration present on the adjacent lane of the host vehicle at a hue different from the vehicle icons of the remaining surrounding vehicles.

3. The autonomous driving system according to claim 1, wherein the processer is configured to display the vehicle icon of the vehicle necessitating deceleration present on the adjacent lane of the host vehicle in a first display mode, and the vehicle icon of a first preceding vehicle positioned in front of the host vehicle in the driving lane of the host vehicle and closest to the host vehicle in a second display mode, which is different in hue from the first display mode.

4. The autonomous driving system according to claim 3, wherein the first display mode is a chromatic color, and the second display mode is an achromatic color.

5. The autonomous driving system according to claim 3, wherein, when a surrounding vehicle present on the adjacent lane of the host vehicle and displayed on the display device is set to the vehicle necessitating deceleration, the processor is configured to change the display mode of the vehicle icon of the surrounding vehicle to the first display mode.

6. A method for controlling a vehicle comprising: a vehicle detection device for detecting surrounding vehicles; and a display device for displaying the surrounding vehicles detected by the vehicle detection device as vehicle icons, the method including:
setting, as a vehicle necessitating deceleration, a surrounding vehicle present on an adjacent lane of the vehicle and predicted to be entered into a driving lane of the vehicle in front of the vehicle among the surrounding vehicles detected by the vehicle detection device;
controlling acceleration and deceleration of the vehicle so that the vehicle does not approach the vehicle necessitating deceleration; and
when a plurality of surrounding vehicles detected by the vehicle detection device are displayed on the display device, displaying a vehicle icon of the vehicle necessitating deceleration so that the vehicle necessitating deceleration is emphasized.
